(19) United States
(12) Patent Application Publication
(10) Pub. No.: US 2003/0119567 A1
(43) Pub. Date: Jun. 26, 2003

(54) Battery cap and wireless transmitter-receiver circuit assembly for mobile telephone

(76) Inventor: Ming Hsun Lin, Tu Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/025,691

(22) Filed: Dec. 26, 2001

(51) Int. Cl. H04B 1/38

(52) U.S. Cl. 455/572; 455/573

(57) ABSTRACT

A battery cap and wireless transmitter-receiver circuit assembly for mobile telephone is constructed to include a battery cap covered on the battery chamber of a mobile telephone, a battery installed in the battery cap, a wireless transmitter-receiver circuit installed in the battery cap, the wireless transmitter-receiver circuit having a signal line adapted for connection to the voice signal input/output jack of the mobile telephone for enabling the mobile telephone to communicate with a remote wireless transmitter-receiver device; and an on/off switch installed in the battery cap and adapted for controlling the operation of the wireless transmitter-receiver circuit.

### BACKGROUND OF THE INVENTION

1. Field of the Invention

The present invention relates to a wireless communication technique and, more specifically, to a battery cap and wireless transmitter-receiver circuit assembly for use with a mobile telephone.

2. Description of the Related Art

Mobile telephones are widely accepted for the advantages of high mobility. In order to keep the head away from the effect of electromagnetic waves, a voice input/output earphone may be used. However, the signal line connecting the earphone to the mobile telephone tends to be tangled. In order to eliminate this problem, wireless communication techniques are developed. FIGS. 1 and 2 show a wireless transceiver 2 for use with a mobile telephone 1. The wireless transceiver 2 has a signal line 21 connected to the voice input/output jack of a mobile telephone 1, for enabling the mobile telephone 1 to communicate a wireless transmitter-receiver earphone 3 carried on the user's ear. FIG. 3 shows a battery charger 4 adapted for charging the battery of the wireless transceiver 2 and the battery of the wireless transmitter-receiver earphone 3. When the wireless transceiver 2 attached to the mobile telephone 1, the combination unit of the wireless transceiver 2 and the mobile telephone 1 is heavy, and inconvenient to carry.

### SUMMARY OF THE INVENTION

The present invention has been accomplished to provide a battery cap and wireless transmitter-receiver circuit assembly for mobile telephone, which eliminates the aforesaid drawbacks. It is therefore the main object of the present invention to provide a battery cap and wireless transmitter-receiver circuit assembly for mobile telephone, make it only one carrier, convenient to carry. According to one aspect of the present invention, the battery cap and wireless transmitter-receiver circuit assembly for mobile telephone comprises a battery installed in the battery cap of a mobile telephone; and a wireless transmitter-receiver circuit installed in the battery cap, the wireless transmitter-receiver circuit having a signal line adapted for connection to the voice signal input/output jack of the mobile telephone for enabling the mobile telephone to communicate with a remote wireless transmitter-receiver device. According to another aspect of the present invention, an on/off switch is installed in the battery cap and adapted for controlling the operation of the wireless transmitter-receiver circuit. According to the still another aspect of the present invention, the battery cap and wireless transmitter-receiver circuit assembly for mobile telephone further comprises an indicator light installed in the battery cap for indicating the working status of the wireless transmitter-receiver circuit.

### BRIEF DESCRIPTION OF THE DRAWINGS

FIG. 1 illustrates a wireless transceiver connected to a mobile telephone according to the prior art.

FIG. 2 illustrates a wireless communication system formed of a wireless transmitter-receiver earphone and the wireless transceiver shown in FIG. 1.

FIG. 3 illustrates the use of a battery charger with a wireless transceiver and a wireless transmitter-receiver earphone according to the prior art.

FIG. 4 is an exploded view of the present invention.

FIG. 5 is an elevational assembly view of FIG. 4.

FIG. 6 illustrates a battery charger used with the battery cap and wireless transmitter-receiver circuit assembly for mobile telephone and a wireless transmitter-receiver earphone according to the present invention.

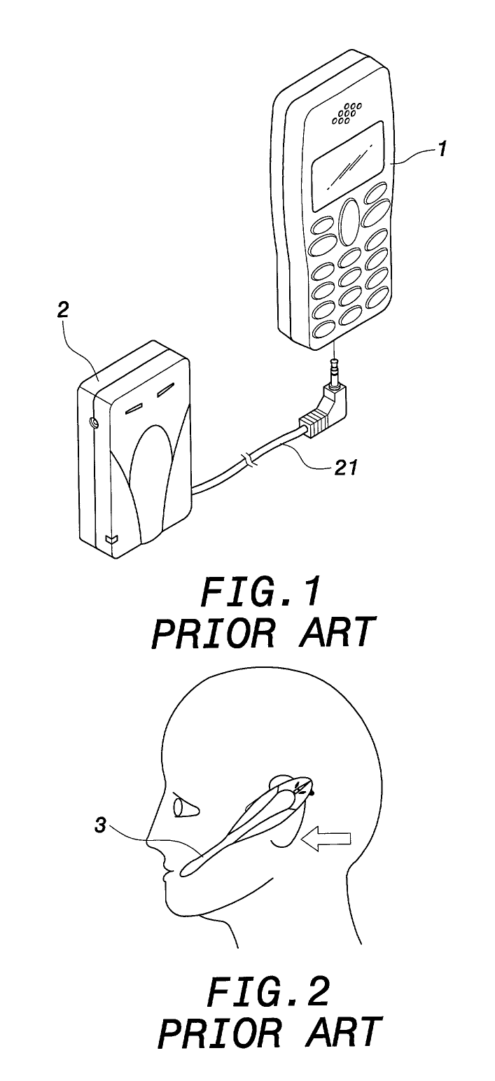

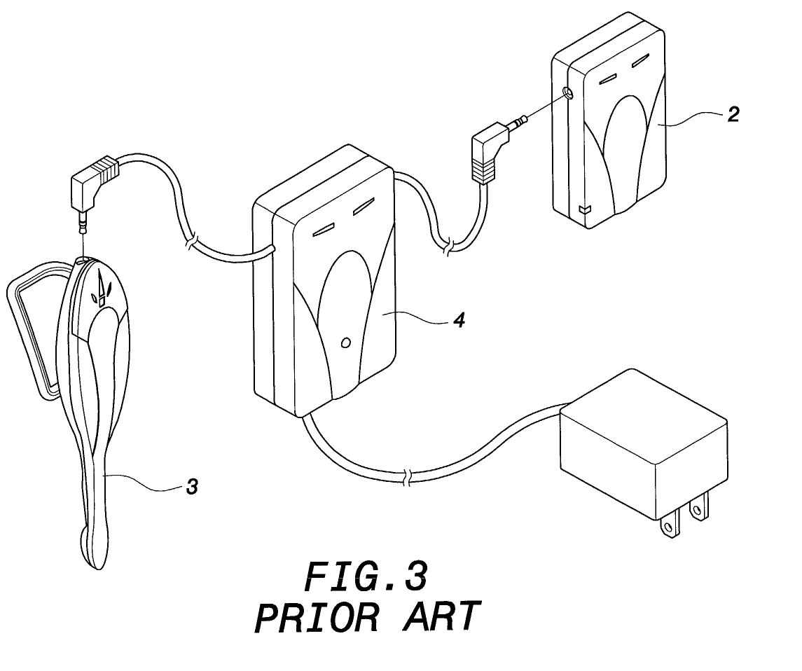

### DETAILED DESCRIPTION OF THE PREFERRED EMBODIMENT

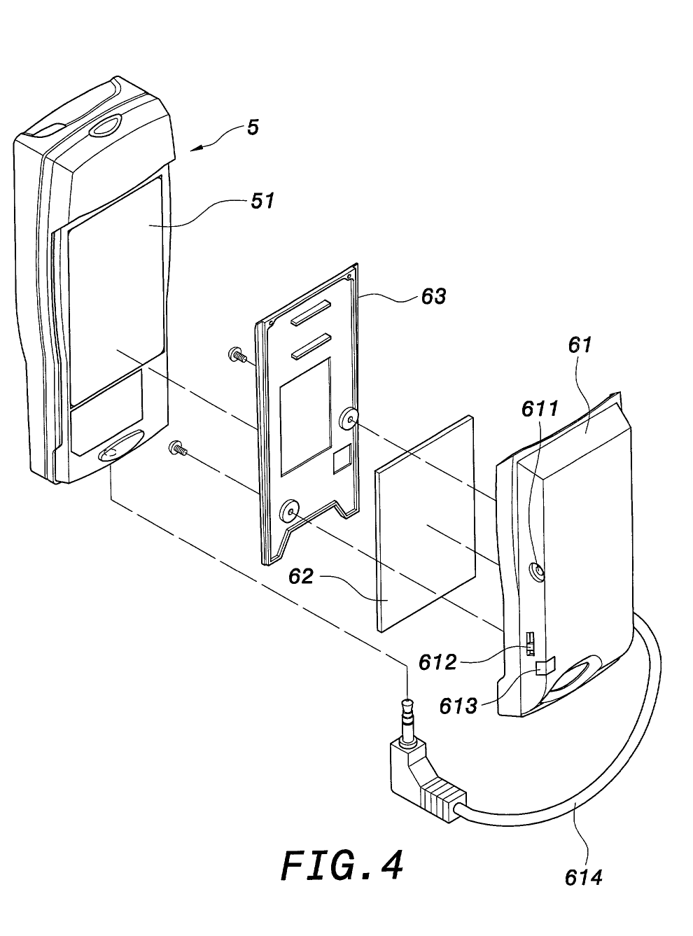

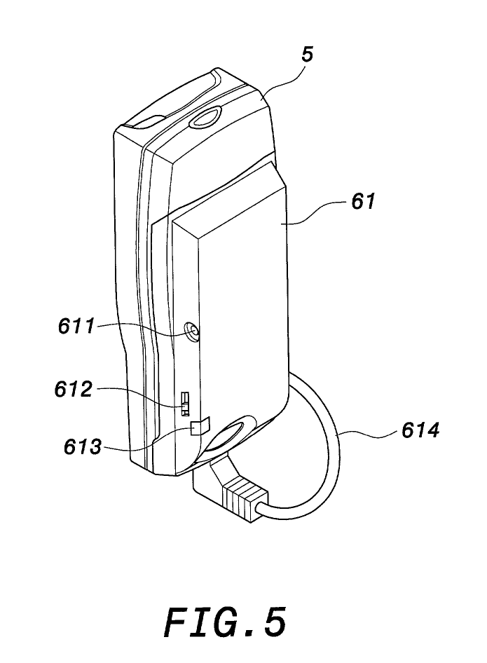

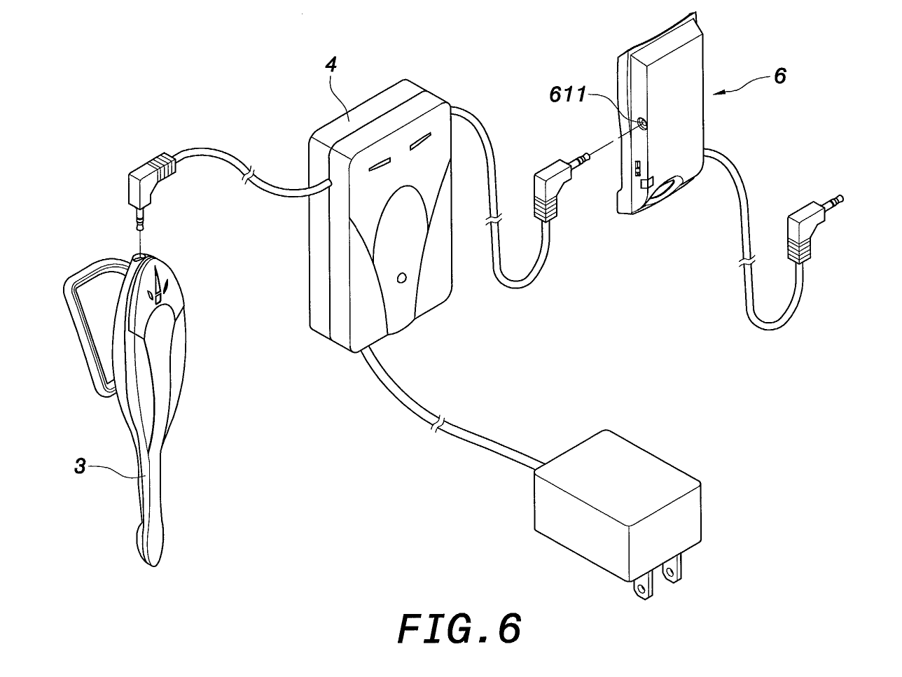

Referring to FIGS. 4 and 5, a battery cap and wireless transmitter-receiver circuit assembly for mobile telephone in accordance with the present invention is shown comprised of a battery cap 61, a battery 64, a signal line 614, a wireless transmitter-receiver circuit 62, and an electrically insulative sealing cover 63. The battery cap 61 is fastened to the backside of a mobile telephone 5 to hold a battery 51 positively in the battery chamber at the backside of the mobile telephone 5. The wireless transmitter-receiver circuit 62 is made in the form of a circuit board mounted inside the battery cap 61. The battery 64 installed inside the battery cap 61. The sealing cover 63 is fastened to the backside of the battery cap 61 to protect the wireless transmitter-receiver circuit 62. The signal line 614 extends from the wireless transmitter-receiver circuit 62 to the outside of the battery cap 61 for connection to the bottom earphone jack (not shown) of the mobile telephone 5 for voice signal input/output.

The battery cap 61 comprises a charging jack 611 adapted for receiving a battery charger to charge the battery 64 installed inside the battery cap 61, an on/off switch 612 adapted for turning on/off the wireless transmitter-receiver circuit 62, an indicator light 613 adapted for indicating the working status of the wireless transmitter-receiver circuit 62. The battery 64, the charging jack 611, the on/off switch 612, the indicator light 613, and the aforesaid signal line 614 are respectively electrically connected to the wireless transmitter-receiver circuit 62.

After installation of the wireless transmitter-receiver circuit 62, in the battery cap 61, the sealing cover 63 is covered on the wireless transmitter-receiver circuit 62 and fixedly fastened to the backside of the battery cap 61. When assembled, the battery cap and wireless transmitter-receiver circuit assembly 6 for mobile telephone functions as a wireless transceiver (see also FIG. 6).

Referring to FIG. 6, and FIGS. 4 and 5 again, the battery cap and wireless transmitter-receiver circuit assembly 6 for mobile telephone (see also FIG. 6) is closed on the back side of the mobile telephone 6, and the signal line 614 is connected to the bottom earphone jack of the mobile telephone 5. Referring to FIG. 6 again, a battery charger 4 may be used to charge the battery 64 in the battery cap and wireless transmitter-receiver circuit assembly 6 for mobile telephone, or the battery (not shown) in the wireless transmitter-receiver earphone 3.

A protocol of battery cap and wireless transmitter-receiver circuit assembly for mobile telephone has been constructed with the features of the annexed drawings of FIGS. 4-6. The battery cap and wireless transmitter-receiver circuit assembly for mobile telephone functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A battery cap and wireless transmitter-receiver circuit assembly for mobile telephone comprising:
a battery cap covered on a mobile telephone;
a battery installed in said battery cap;
a wireless transmitter-receiver circuit installed in said battery cap, said wireless transmitter-receiver circuit comprising a signal line adapted for connection to a voice signal input/output jack in said mobile telephone for enabling said mobile telephone to communicate with a remote wireless transmitter-receiver device; and
an on/off switch installed in said battery cap and adapted for controlling the operation of said wireless transmitter-receiver circuit.

2. The battery cap and wireless transmitter-receiver circuit assembly for mobile telephone as claimed in claim 1, wherein said battery cap comprises a charging jack electrically connected to the battery installed in said battery cap and adapted for receiving a battery charger to charge the battery installed in said battery cap.

3. The battery cap and wireless transmitter-receiver circuit assembly for mobile telephone as claimed in claim 1 further comprising an indicator light installed in said battery cap for indicating the working status of said wireless transmitter-receiver circuit.

4. The battery cap and wireless transmitter-receiver circuit assembly for mobile telephone as claimed in claim 1 further comprising an electrically insulative sealing cover fastened to a back side of said battery cap and covered on said wireless transmitter-receiver circuit.

5. The battery cap and wireless transmitter-receiver circuit assembly for mobile telephone as claimed in claim 1, wherein the battery installed in said battery cap is a rechargeable storage battery.
